(19) United States
(12) Patent Application Publication
(10) Pub. No.: US 2005/0269379 A1
(43) Pub. Date: Dec. 8, 2005

(54) Apparatus for threading webs into units of rotary presses

(75) Inventors: Helmut Schnell, Augsburg (DE); Christian Winterholler, Friedberg (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: MAN Roland Druckmaschinen AG, Offenbach am Main (DE)

(21) Appl. No.: 11/122,531

(22) Filed: May 5, 2005

(30) Foreign Application Priority Data
May 5, 2004 (DE) 10 2004 022 541.9

(51) Int. Cl. B41F 13/03; G03B 1/56; D21F 1/36

(52) U.S. Cl. 226/91; 226/92

(57) ABSTRACT

The invention relates to an apparatus for threading webs into rotary presses that enables automatic paper threading. The apparatus includes a flexible threading element for guiding the web through a folder of the rotary press. The flexible threading element is guided in a threading guide and is movable by a drive. The threading element following the web is inclined with respect to a longitudinal axis of the web and rotated about the longitudinal axis.

### FIIED OF THE INVENTION

The invention relates to an apparatus for threading webs into units of rotary presses.

### BACKGROUND OF THE INVENTION

An apparatus for threading webs into units of rotary presses is disclosed in DE 24 02 768 C2. With this apparatus, insertion of the web from the reel changer as far as the folding former is possible. However, a disadvantage with this apparatus is that the paper web has to be threaded manually into the folder.

### BRIEF SUMMARY OF THE INVENTION

In view of the foregoing, a general object of the present invention is to provide an apparatus for threading webs into rotary presses which enables automatic paper threading, thereby eliminating manual threading activities.

According to the invention, at least one web is threaded into units of rotary presses, in particular folders. The web is connected to the threading element being guided through the folder with at least one flexible threading element. The flexible threaded element is guided in threading guides and can be moved by means of at least one drive. The threading element, following the web, is inclined with respect to its longitudinal axis and is guided around its longitudinal axis in the direction of the center of the former. In the folder, the threading element runs through and between transport elements and cross-cutting devices that are thrown off or disengaged from one another.

Therefore, the web (e.g., a paper web) folded by the former can be pulled into the folder or into the folding unit and thus conveyed through the entire machine, i.e. from the unwind unit as far as the folding unit. A suitable threading element preferably comprises a threading chain that includes chain links that can be intrinsically rotated to such an extent that, over or along the length of the former, rotation of the threading chain, in particular the chain links, through at least 90° is possible. Therefore, the change in direction or rotation of the web can be carried out. The chain links preferably have a conical shape. Alternatively, a rope or a tape can also be used as a threading element. The threading guide is, for example, configured as a rail.

The threading guide is arranged outside the roll region, and in particular between shaft or axle journals of the transport elements or cross-cutting device. Through this arrangement, a collision between the transport elements and cross-cutting device, thrown on to or engaged with one another during machine operation, and the threading guide running in the folding unit is avoided. This allows the threading guide to remain in the folder during machine operation.

The start of the web is cut to a point or torn off. A hook-in apparatus fixes the web in a region which, at most, is half the width of the web. Behind the hook-in apparatus, the portion of the web cut to a point extends as far as the full web width. When the web is pulled over the former, first the region of the web fixed in the hook-in apparatus as described above is placed around a former edge with the first web edge being rotated through 90° about its longitudinal axis. During further threading of the web over the former and into the folding unit, the web width increases as far as the full web width. As a result of the pulling action, the opposite web edge is automatically pulled over the other former edge and this is likewise rotated through 90° about its longitudinal axis. Thus, the full-width web is ultimately folded longitudinally over the former.

By means of the threading element following the defined threading path of a web edge in an appropriate manner, the web is pulled over the former in the direction of the center of the former or folding unit and then into the folding unit. As a result of threading the web or web edge with a threading element in this manner (i.e., single-sided paper threading), an offset of the web on the former towards the center of the machine can arise. This offset can be eliminated, as far as its equalization at the cross-cutting device, by an appropriately accommodating threading point storage unit outside the machine. The web is pulled until the aforementioned offset has been carried out by means of aligning the web by the deflection rolls of the paper guidance system. In this position, threading point storage capacity is still available.

Once the centering of the paper web on the former and the parallel relationship of the paper web on the cross-cutting device has been achieved, this device, initially disengaged into a threading position, is connected up to the machine (the individual section therefore begins) and the apparatus is able to convey the entire paper threading section out of the machine by utilizing the threading point storage capacity that is still available. By means of engaging and connecting the cross-cutting device, a defined cut of the paper web is therefore made without any scraps of paper being produced, since the severed paper threading section is conveyed out of the folder. In conjunction with engaging the cross-cutting device, all the remaining elements conveying the paper web or otherwise in engagement with the paper web are preferably engaged with the paper web at the same time. The paper web is thus fixed in its position.

The apparatus thus permits automatic or fully automatic paper conveyance from the reel to the individual copy. While the reel is being prepared for a new threading operation, the threading element is returned after the removal of the existing paper section in the storage unit. The return of the threading element can be carried out on a separate threading guide outside the rotary press as far as the unwind unit. The change between the transverse and longitudinal direction is carried out in a manner analogous to that already described above. The reversal of direction of the threading chain requires suitable hook-in elements for fixing the hook-in apparatuses to both ends of the threading chain.

The threading guide is arranged such that it can be moved on or by the former and/or with the former. In particular, the threading guides of the former and folding unit can be displaced synchronously with one another such that the threading guides are not offset, i.e. they are congruent.

In order to determine the offset of the paper web on the former, sensors or other measuring devices can be arranged so as to be able to measure the offset.

The invention is not intended to be restricted to a threading element that is guided in a threading guide along the threading path of a web edge and by means of which the web is thus threaded into the folding unit on one side. Alternatively, starting from the unwind unit, the web can be threaded as far as the folding unit in such a way that a threading element guided in a threading rail and running in accordance with the threading path of the two web edges is used. This means that via two threading elements that fix the start of the web in the vicinity of the two web edges, the web is threaded from the unwind unit as far as the folding unit. As a result, the start of the web to be threaded would no longer have to be cut to a point or torn. Instead, under certain circumstances, only one hook-in apparatus that extends over the entire web width or two hook-in apparatuses with at most half the full web width could be used.

### BRIEF DESCRIPTION OF THE SEVERAL VIEWS OF THE DRAWING(S)

FIG. 1 is a side view of an exemplary web threading apparatus according to the present invention showing a web being threading in the area of the folder.

FIG. 2 is a further side view of the web threading apparatus of FIG. 1.

### DETAILED DESCRIPTION OF THE INVENTION

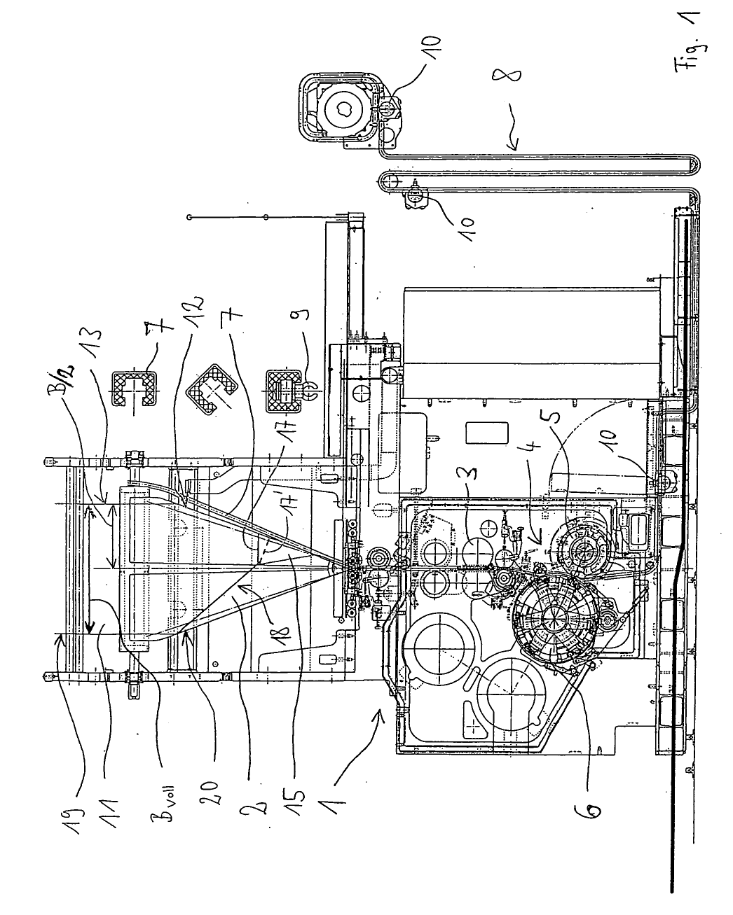

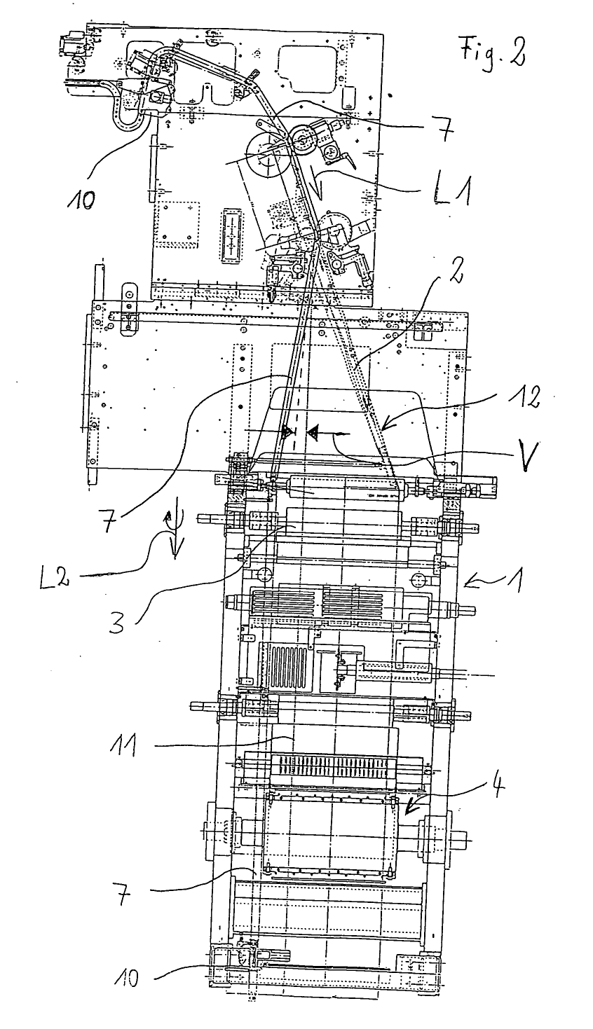

Referring now to the drawings, the folder 1 illustrated schematically in FIG. 1 and FIG. 2 includes a former 2 and a folding unit 14. The folding unit 14 includes at least one pair of transport elements 3 designed as pull rolls and a cross-cutting device 4. Preferably, the former 2 can be moved in its position in the horizontal and/or vertical direction. The cross-cutting device 4 includes a cutting cylinder 5 and a pin and folding-blade cylinder 6 or a gripper cylinder (not shown). As shown in FIG. 1, further guide, transport and pulling elements (not specifically designated) can be arranged between the former 2 and the cross-cutting device 4.

A threading guide 7 is arranged along the former 2 and between the elements which can be brought into engagement with or thrown onto the web 11 (preferably a paper web), such as cross-cutting device 4, pulling elements, etc. The threading guide 7 defines the threading path of the paper web 11 through the folder 1 and is preferably configured as a rail. The threading guide 7 can be made of plastic, metal or plastic-coated metal and has a U-shaped or C-shaped cross section with angled-over ends. Behind the cross-cutting device 4, the threading rail 7 is configured as a threading-point store or storage unit 8. A driven chain wheel 10 is arranged at the end of this storage unit 8 or along the threading path. The driven chain wheel 10 is in engagement with a threading element 9 guided in the threading guide 7. The threading element 9 preferably is configured as a threading chain. This chain wheel 10 helps carry out the transport of the threading chain 9 and thus also the transport of the paper web 11 arranged on the threading chain 9. The driven chain wheels 10 are arranged in accordance with the length of the threading chain 9.

In order to fix the web 11 or its web edge 13 to the threading chain 9, a hook-in apparatus 15 is provided, as is known from the textbook “Der Rollenoffset” [Web-fed Offset], Wolfgang Walenski. Page 133, Fachschriften-Verlag, first edition 1995, the disclosure of which is incorporated herein by reference. A start 18 of the web 11 is cut to a point or torn off and a hook-in apparatus 15 fixes the web 111 in a region 16 which is at most half the web width B/2. To this end, the hook-in apparatus 15 is designed to be at most half the web width B/2. In this region 16, the web 111 has a leading cut edge 17, 17′ that runs in a point or horizontally. Behind the hook-in apparatus 15, the web 11 runs cut to a point as far as the full web width Bfull.

As the web 11 is pulled over the former 2, the region 16 of the web 111 fixed in the hook-in apparatus 15 first runs around a former edge 12 with a first web edge 13 being rotated through 90° about its longitudinal axis. During further threading of the web over the former 2 and into the folder unit 14, the web width increases up to the full web width Bfull. The opposite web edge 19 is pulled automatically over the other former edge 20 by the pulling action and likewise is rotated through 90° about its longitudinal axis. Thus, ultimately, the full-width web Bfull is folded longitudinally over the former and can then be threaded into the folding unit 14.

In order to move the threading chain 9 from the horizontal plane into a vertical plane along the former 2 or the former edge 12 and subsequently into a further vertical plane through the folder 1, the threading element 9 following the web 11 is inclined with respect to its longitudinal axis (longitudinal direction L1)and the threading element 9 is guided in the longitudinal direction L2 running vertically (see FIG. 2) rotated about its longitudinal axis in the direction of the center of the folder. The threading element 9 runs through the folder between transport elements and cross-cutting devices that are thrown off or disengaged from one another. Therefore, the paper web 11 folded by the former 2 can be threaded into the folder 1 and thus conveyed through the entire machine, i.e. from the unwind unit as far as the folding unit 14.

The threading chain 9 includes a plurality of chain links that can be intrinsically rotated. The chain links preferably have conical configurations and are rotatable through at least 90° over a length corresponding to the overall former dimensions and the former geometry. The use of roller chains as a threading chain 9 lowers the friction and the operation produces less noise. In addition, the at least one driven chain wheel 10 that engages in the threading chain 9 allows for simple, uniform and good control of the drive of the entire threading apparatus. The use of a threading guide 7 that is designed as a threading rail, preferably made of plastic with a standardized profile, in conjunction with roller chains as a threading element, permits quiet running and simple production. At the same time, extending the threading path based in a fashion can be easily carried out.

Because of the one-sided arrangement of the threading guide 7 on the former 2 and therefore the one-sided paper threading, a web offset is produced on the former 2. Equalizing an offset V on the cross-cutting device 4 can be accomplished with an appropriately accommodating threading point storage unit 8 outside the machine with the paper web 11 being pulled until the aforementioned offset V no longer exists. Once the parallel relationship of the paper web 11 on the cross-cutting device 4 has been achieved, the initially thrown-off or disengaged cross-cutting device is connected up to the machine (the individual section therefore begins) and the apparatus is able to convey the entire paper threading section out of the machine. During threading, the pin and folding-blade cylinder 6 and/or the cutting cylinder 5 are in a threading position. All the elements are preferably thrown off or disengaged from one another during the threading operation, so that the paper web 11 can be threaded without contact.

The threading guide 7 is arranged such that it can be moved on or by the former 2 and/or with the former 2. In particular, the threading guides 7 of former 2 and folder 1 can comprise a plurality of parts that can be displaced synchronously with one another such that these threading guides are not offset, i.e. they are congruent.

In order to determine the offset V of the paper web 11 on the former 2, sensors or other measuring devices can be provided. These sensors or measuring devices are preferably connected to a machine control system or other computing, control and/or regulating device. If the sensors or measuring devices should detect that the predefined position of the paper web on the former 2 and on the cross-cutting device 4 has been reached, the machine control system or other computing, control and/or regulating device is automatically notified. The fixing elements and the cross-cutting device 4 can then be activated by the machine control system. At the same time, both the paper web 11 is fixed and the first defined cut is brought about by means of throwing on or engaging the cross-cutting device 4.

Reference Symbols:

1. Folder
2. Former
3. Pull roll
4. Cross-cutting device
5. Cutting cylinder
6. Pin and folding-blade cylinder
7. Threading guide
8. Threading point store
9. Threading element
10. Chain wheel
11. Web
12. Former edge
13. Web edge
14. Folding unit
15. Hook-in apparatus
16. Region
17. Cut edge
18. Start of the web
19. Web edge
20. Former edge
L1. Longitudinal direction
L2. Longitudinal direction
V. Offset

1. A web threading apparatus for threading a web into a folder of a rotary press comprising a flexible threading element for guiding the web through the folder, the flexible threading element being guided in a threading guide and being movable via a drive, the threading element following the web being inclined with respect to a longitudinal axis of the web and rotated about the longitudinal axis.

2. The web threading apparatus according to claim 1, wherein the threading guide comprises a rail.

3. The web threading apparatus according to claim 1, further including a second flexible threading element and wherein the two flexible threading elements are arranged on opposite edges of the web.

4. The web threading apparatus according to claim 1, wherein the threading guide runs between shaft journals of transport elements and a cross-cutting device.

5. The web threading apparatus according to claim 1, wherein the flexible threading element comprises a threading chain including intrinsically rotatable chain links.

6. The web threading apparatus according to claim 5, wherein the flexible threading element has chain links that are intrinsically rotatable such that rotation of the flexible threading element through at least 90° is possible over the length of a former of the folder.

7. The web threading apparatus according to claim 1, wherein the threading guide is arranged as far as an unwind unit of the rotary press.

8. The web threading apparatus according to claim 1, wherein the threading guide after a cross-cutting device comprises a threading storage unit.

9. The web threading apparatus according to claim 8, wherein a start of the web is threadable into the threading storage unit until an offset in the web offset present on the former during the threading operation is eliminated.

10. The web threading apparatus according to claim 9, wherein the cross-cutting device engages with the web following a centering of the web on the former and achieving a parallel relationship of the web on the cross-cutting device, the web being fixed by the cross-cutting device and a defined cut being carried out to produce a severed web start, the severed web start being conveyable out of the folder into the threading storage unit.

11. The web threading apparatus according to claim 9, wherein sensors are provided to determine the offset of the web.

12. The web threading apparatus according to claim 1, wherein the threading guide is movable by the former.

13. The web threading apparatus according to claim 12, wherein the threading guide comprises a plurality of parts that can be displaced synchronously with one another and in alignment with one another.

14. The web threading apparatus according to claim 1, wherein the flexible threading element is returned to an unwind unit in a further threading guide arranged outside the rotary press.

15. The web threading apparatus according to claim 1, wherein a start of the web is configured with a point and a hook-in apparatus fixes the web in a region that is at most half the width of the web.

16. The web threading apparatus according to claim 15, wherein the hook-in apparatus is designed with at most half the web width.

17. The web threading apparatus according to claim 15, wherein the hook-in apparatus can be arranged at both ends of the threading element.
